(19) United States
(12) Patent Application Publication
(10) Pub. No.: US 2006/0095780 A1
(43) Pub. Date: May 4, 2006

(54) System and method to facilitate importation of user profile data over a network

(76) Inventors: W. Daniel Hillis, Encino, CA (US); Bran Ferren, Beverly Hills, CA (US)

Correspondence Address: GLENN PATENT GROUP, 3475 EDISON WAY, SUITE L, MENLO PARK, CA, 94025, US

(21) Appl. No.: 10/976,696

(22) Filed: Oct. 28, 2004

(51) Int. Cl. H04L 9/00

(52) U.S. Cl. 713/182

(57) ABSTRACT

A system and method to facilitate importation of user profile data over a network are described. In one preferred embodiment, a request to import the user profile data is received from a user, the user profile data being stored in a source user account within a source entity. Prior to importation of the user profile data, the source user account is authenticated as being associated with the user. Subsequent to the authentication, the user profile data is received from the source entity and is merged within a destination user account associated with the user. Alternatively, the user profile data may be used to create a destination user account associated with the user.

### TECHNICAL FIELD

The invention relates generally to the field of network-based communications and, more particularly, to a system and method to facilitate importation of user profile data over a network, such as the Internet.

### BACKGROUND OF THE INVENTION

The explosive growth of the Internet, and of its subset, the World Wide Web (Web), as a publication and interactive communication platform has created an electronic environment that is changing the way business is transacted. Many sites found on the Web allow users to create a user profile and to store data related to the user in the user profile. In some instances, the user may modify such data by accessing the user profile within the site, while in other instances data may be modified by other users according to specific rules developed by the site.

For example, many sites allow users to accumulate a reputation based on feedback information entered by participants in transactions on the particular site. Following the completion of a transaction, the participants may enter positive or negative “feedback” evaluating the honesty, reliability, and/or promptness of their transactional counterparts. Over time, evaluations of a particular user accumulate in the user profile, allowing prospective transactional counterparts of the user to assess the reputation of the user prior to any potential transaction.

In another example, certain sites allow users to develop a reputation using indirect means. Users are allowed to submit reviews of products listed on the site, such as, for example books or other literary works. Subsequent visitors to the site may read such reviews and judge their usefulness. The users who gather positive comments are considered top reviewers and their reputation is enhanced.

In yet another example, certain sites allow users to submit comments on stories posted by the editors of that particular site. Other users can subsequently evaluate such comments by assigning various descriptive attributes, such as “funny” or “informative.” A resulting score is computed for each comment posted on the site, with predetermined positive attributes increasing the score and predetermined negative attributes lowering the score.

While such attempts appear to be useful within each respective site, the scope of such ratings is limited. The user profile data defines the user within the universe of the site and is not portable from site to site. Thus, what is needed is a system and method to facilitate importation of user profile data from one entity to another over a network, such as, for example, the Internet.

### SUMMARY OF THE INVENTION

A system and method to facilitate importation of user profile data over a network are described. In one preferred embodiment, a request to import the user profile data is received from a user, the user profile data being stored in a source user account within a source entity. Prior to importation of the user profile data, the source user account is authenticated as being associated with the user. Subsequent to the authentication, the user profile data is received from the source entity and is merged within a destination user account associated with the user. Alternatively, the user profile data may be used to create a destination user account associated with the user.

### BRIEF DESCRIPTION OF THE DRAWINGS

FIG. 1 is a block diagram illustrating an exemplary network-based system, which facilitates importation of user profile data, according to one embodiment of the invention;

FIG. 2 is a flow diagram illustrating a method to facilitate importation of user profile data, according to one embodiment of the invention;

FIG. 3 is a flow diagram illustrating a method to authenticate a user and a corresponding source user account, according to one embodiment of the invention;

FIG. 4 is a flow diagram illustrating a method to authenticate a user and a corresponding source user account, according to an alternate embodiment of the invention;

FIG. 5 is a flow diagram illustrating a method to authenticate a user and a corresponding source user account, according to another alternate embodiment of the invention;

FIG. 6 is a diagrammatic representation of a machine in the exemplary form of a computer system within which a set of instructions may be executed.

### DETAILED DESCRIPTION

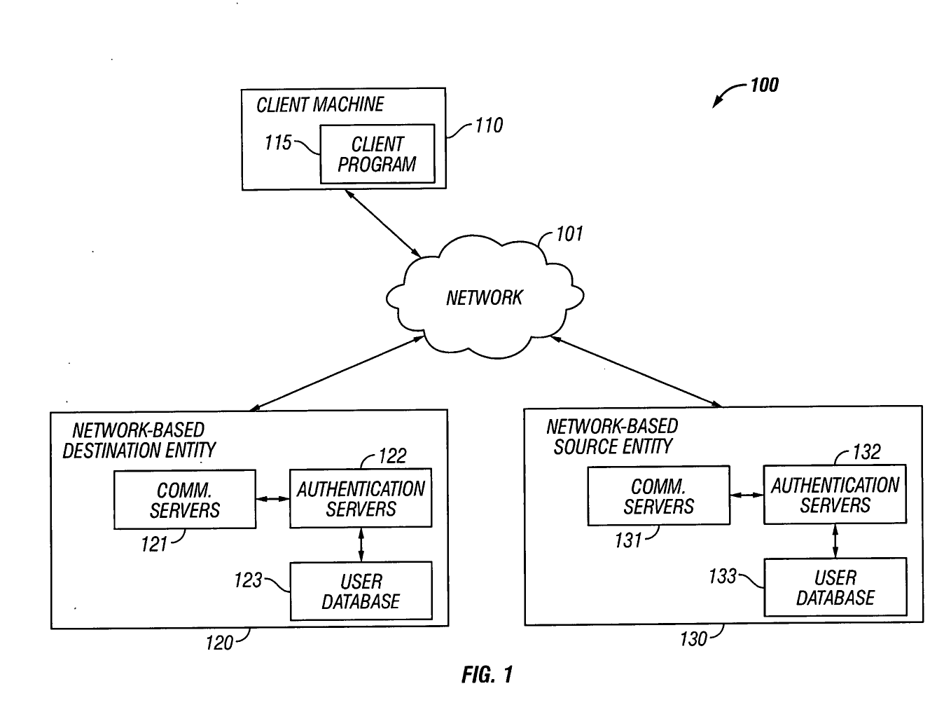

FIG. 1 is a block diagram illustrating an exemplary network-based system 100, which facilitates importation of user profile data, according to one embodiment of the invention. While an exemplary embodiment of the invention is described within the context of network-based transaction and communications entities, it will be appreciated by those skilled in the art that the invention will find application in many different types of computer-based, and network-based, commerce facilities.

As illustrated in FIG. 1, in one embodiment, the system 100 includes a network-based destination entity 120 and one or more network-based source entities, of which source entity 130 is shown in FIG. 1. Each entity 120, 130 is a transaction and communications facility to enable users to communicate and participate in transactions over a network 101, such as, for example, commercial transactions, discussions, authorship, contributions, and other transactions. Each entity 120, 130 includes one or more of a number of types of front-end servers, such as, for example, respective communication servers 121, 131 that provide, inter alia, automated real-time communications, such as, for example, instant messaging (IM) functionality, to/from users of each entity 120, 130, and automated email communications to/from users. Each entity 120, 130 may alternatively include other known types of servers, such as page servers, which deliver web pages to multiple users, e.g. markup language documents, and/or picture servers, which dynamically deliver images to be displayed within the web pages.

Each entity 120, 130 further includes one or more back-end servers, such as, for example, respective authentication servers 122, 132 that facilitate authentication of users requesting access to the entities 120, 130. The authentication servers 122, 132 maintain and facilitate access to respective user databases 123, 133, configured to store user accounts containing user profile data and other data related to users of the entities 120, 130.

The databases 123, 133 may, in one embodiment, be implemented as relational databases, and may include a number of tables having entries, or records, that are linked by indices and keys. In an alternative embodiment, the databases 123, 133 may be implemented as a collection of objects in an object-oriented database. The user accounts for each respective entity 120, 130 are stored in user tables that can be accessed by the authentication servers 122, 132. In one embodiment, the user profile data within each user account includes, for example, reputation data accumulated for each user as a result of completion of transactions using the respective entities 120, 130.

The network-based entities 120, 130 may be accessed by a client program 115, such as a browser, e.g. the Internet Explorer browser distributed by Microsoft Corporation of Redmond, Wash., that executes on a client machine 110 and accesses the entities 120, 130 via the network 101, such as, for example, the Internet. Other examples of networks that a client may utilize to access the entities 120, 130 includes a wide area network (WAN), a local area network (LAN), a wireless network, e.g. a cellular network, the Plain Old Telephone Service (POTS) network, or other known networks.

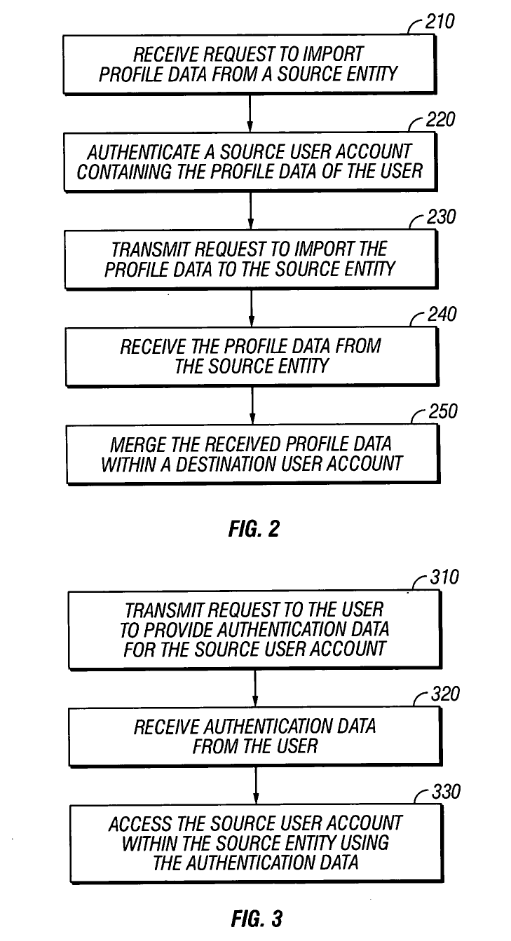

FIG. 2 is a flow diagram illustrating a method to facilitate importation of user profile data, according to one embodiment of the invention. As illustrated in FIG. 2, at processing block 210, a request to import user profile data from a source entity is received from a user. In one embodiment, a user connects to the destination entity 120 via the network 101 and communications servers 121 and transmits a request to import user profile data from a user account stored within the source entity 130, the user profile data including, for example, reputation data accumulated for the user as a result of completion of transactions with the source entity 130. In one embodiment, the request is transferred to the authentication servers 122 for further authentication of the user and of the user account within the source entity 130.

Referring to FIG. 2, at processing block 220, the source user account containing the user profile data is authenticated. In one embodiment, the authentication servers 122 within the destination entity 120 prompt the user via the network 101 to demonstrate that the user is the owner of the source user account, thereby authenticating the transfer of user profile data.

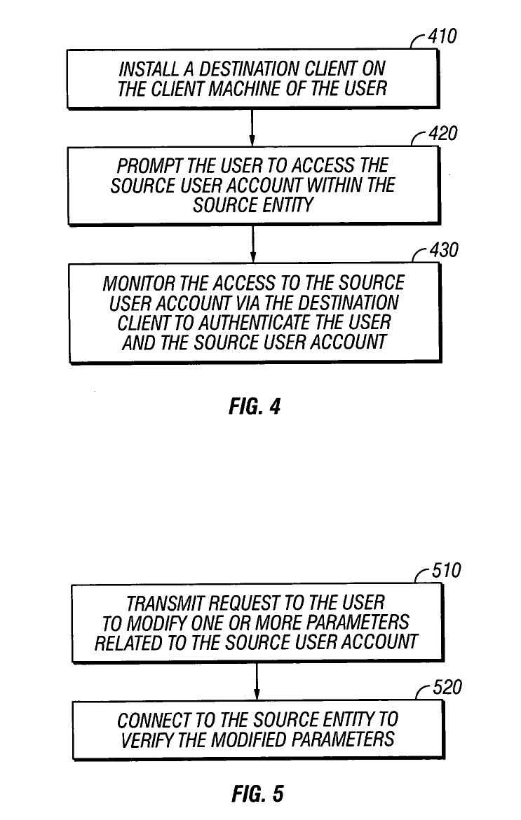

In one embodiment, as further described in detail in connection with FIG. 3, the authentication servers 122 request authentication data directly from the user, such as, for example, a valid password for the source user account, and use the password to authenticate the transfer. In an alternate embodiment, as further described in detail in connection with FIG. 4, the authentication servers 122 authenticate the source user account by monitoring the user through the client machine 110 as the user performs an authentication action that necessarily requires access to the source user account. In another alternate embodiment, as further described in detail in connection with FIG. 5, the authentication servers 122 may request the user to provide an outwardly visible change on the source entity via the source user account.

Referring back to FIG. 2, at processing block 230, subsequent to successful authentication of the source user account, a request to import the user profile data is transmitted to the source entity 130. In one embodiment, the destination entity 120 connects to the source entity 130 via the network 101 and communications servers 121, 131 and the request to import the user profile data is transmitted to the source entity 130. The authentication servers 131 receive the request, retrieve the user profile data from the respective tables within the user database 133 and transmit the user profile data back to the destination entity 120. In an alternate embodiment, the user may request the transfer of profile data from the source entity 130 to the destination entity 120 via the client machine 110 and the network 101.

At processing block 240, the user profile data is received from the source entity 130. In one embodiment, the authentication servers 122 within the destination entity 120 receive the user profile data from the source entity 130 via the network 101.

Finally, at processing block 250, the received user profile data is merged within a destination user account. In one embodiment, the authentication servers 122 merge the user profile data received from the source user account into the destination user account stored in the destination user database 123, which also contains user profile data accumulated for the user as a result of completion of transactions with the destination entity 120. In an alternate embodiment, the user profile data received from the source user account may be used to create or to set up a destination user account for transactions via the destination entity 120. The user may subsequently modify the user profile data by adding new data derived from the transactions completed via the destination entity 120.

FIG. 3 is a flow diagram illustrating a method to authenticate a user and a corresponding source user account, according to one embodiment of the invention. As illustrated in FIG. 3, at processing block 310, a request to provide authentication data for the source user account is transmitted to the user. In one embodiment, the authentication servers 122 request authentication data directly from the user, such as, for example, a valid password for the source user account.

At processing block 320, the authentication data is received from the user. In one embodiment, the user transmits the authentication data, such as, for example the valid password, to the authentication servers 122 via the client machine 110, the network 101, and the communication servers 121.

At processing block 330, the source user account within the source entity 130 is accessed using the authentication data provided by the user. In one embodiment, the authentication servers 122 access the source user account within the source entity 130 and authenticate the source user account using the valid password submitted by the user.

FIG. 4 is a flow diagram illustrating a method to authenticate a user and a corresponding source user account, according to an alternate embodiment of the invention. As illustrated in FIG. 4, at processing block 410, a destination client, such as, for example a destination client program similar to the client program 115, is installed on the client machine 110 of the user. In one embodiment, the authentication servers 122 install the destination client program on the client machine 110 to monitor the activity of the user and any Hyper Text Transfer Protocol (HTTP) transfer requests that the user exchanges with the source entity through the network 101.

At processing block 420, the user is prompted to access the source user account within the source entity 130. In one embodiment, the authentication servers 122 within the destination entity 120 prompt the user to connect to the source entity 130 and to access the source user account. Alternatively, the authentication servers 122 prompt the user to connect to the source entity 130 using a link accessible only with a valid password, thereby authenticating the user and the source user account.

At processing block 430, the access to the source entity 130 and the source user account is monitored via the destination client program to authenticate the user and the source user account. In one embodiment, the authentication servers 122 monitor the user activity via the destination client program installed within the client machine 110 and authenticate the user as the owner of the source user account if the user accesses the source user account within the source entity 130 using a valid password. Alternatively, the authentication servers 122 complete the authentication process if the user connects to the source entity 130 and receives information via a HTTP request from the link accessible only with the valid password.

FIG. 5 is a flow diagram illustrating a method to authenticate a user and a corresponding source user account, according to another alternate embodiment of the invention. As illustrated in FIG. 5, at processing block 510, a request is transmitted to the user to modify one or more parameters related to the source user account within the source entity 130. In one embodiment, the authentication servers 122 within the destination entity 120 transmit a request to the user via the network 101 to modify one or more parameters within the source entity 130, each parameter being related to the source user account and being outwardly visible to the destination entity 120 via the network 101. The user may then communicate with the destination entity 120, the communication detailing modification of the parameter or parameters. For example, if the source user account login procedure provides for a password hint in the event that the user forgets the password for the account, the authentication servers 122 may request the user to alter the password hint as evidence of valid access to the source user account. Specifically, the user may communicate to the destination entity 120 that a change of the password hint from “xxx” to “yyy” will take place after a predetermined period of time. The authentication servers 122 may subsequently request the original password hint and the modified password hint from the source entity 130 and verify the validity of the action.

At processing block 520, the authentication servers 122 within the destination entity 120 connect to the source entity 130 via the network 101 and verify the modified parameters to authenticate the user as the owner of the source user account. In an alternate embodiment, other externally visible changes may be used, such as, for example, a publicly visible transaction (a sale, or a posting of a review or comment) requiring valid access to the source user account may be conducted by the user and the authentication servers 122 may verify such posting of the transaction within the source entity 130.

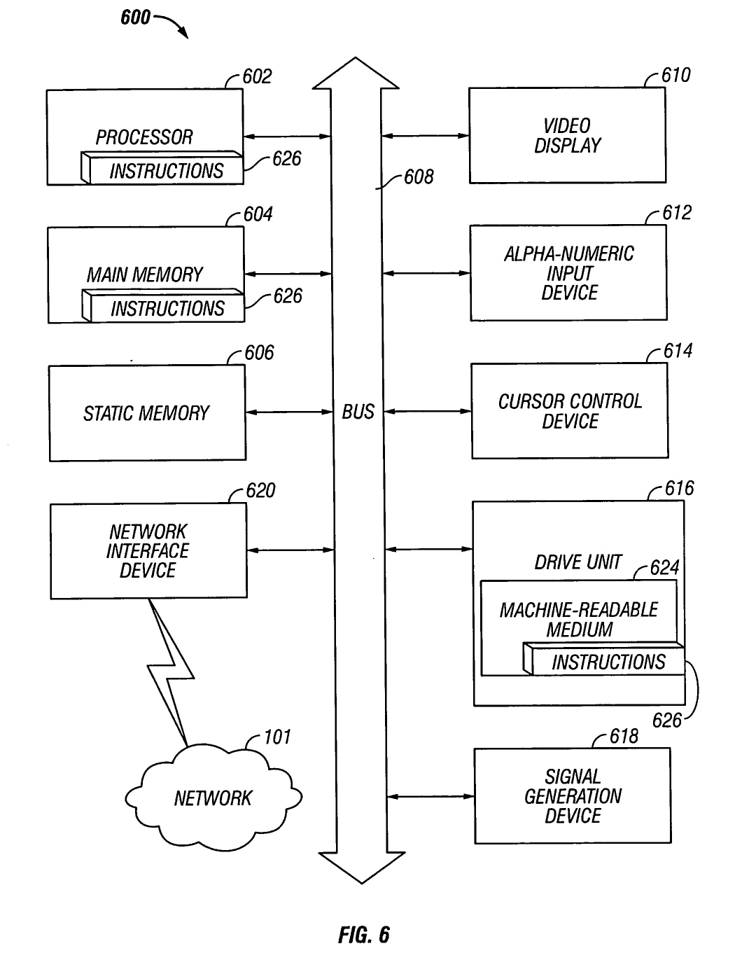

FIG. 6 shows a diagrammatic representation of a machine in the exemplary form of a computer system 600 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 600 includes a processor 602, a main memory 604 and a static memory 606, which communicate with each other via a bus 608. The computer system 600 may further include a video display unit 610, e.g. a liquid crystal display (LCD) or a cathode ray tube (CRT). The computer system 600 also includes an alphanumeric input device 612, e.g, a keyboard, a cursor control device 614, e.g. a mouse, a disk drive unit 616, a signal generation device 618, e.g. a speaker, and a network interface device 620.

The disk drive unit 616 includes a machine-readable medium 624 on which is stored a set of instructions, i.e. software, 626 embodying any one, or all, of the methodologies described above. The software 626 is also shown to reside, completely or at least partially, within the main memory 604 and/or within the processor 602. The software 626 may further be transmitted or received via the network interface device 620.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, e.g. carrier waves, infrared signals, digital signals, etc.; or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method to facilitate importation of user profile data over a network, said method comprising the steps of:
receiving a request to import said user profile data from a user, said user profile data being stored in a source user account within a source entity; and
prior to said importation of said user profile data, authenticating said source user account as being associated with said user.

2. The method according to claim 1, further comprising the steps of:
receiving said user profile data from said source entity; and
merging said user profile data within a destination user account associated with said user.

3. The method according to claim 1, further comprising the steps of:
receiving said user profile data from said source entity; and
using said user profile data to create a destination user account associated with said user.

4. The method according to claim 1, wherein said authenticating step further comprises the steps of:
transmitting a request to said user to provide authentication data for said source user account;
receiving said authentication data; and
accessing said source user account within said source entity using said authentication data.

5. The method according to claim 4, wherein said authentication data is a valid password used to access said source user account.

6. The method according to claim 1, wherein said authenticating step further comprises the steps of:
installing a destination client on a client machine associated with said user;
prompting said user to access said source user account within said source entity; and
monitoring said access of said source user account using said destination client to authenticate said source user account as being associated with said user.

7. The method according to claim 1, wherein said authenticating step further comprises the steps of:
installing a destination client on a client machine associated with said user;
prompting said user to access said source entity using a link accessible only with valid authentication data; and
monitoring said access of said source entity using said destination client to authenticate said source user account as being associated with said user.

8. The method according to claim 7, wherein said monitoring step further comprises the steps of:
determining if said user receives information from said link via a Hyper Text Transfer Protocol (HTTP) request.

9. The method according to claim 1, wherein said authenticating step further comprises the steps of:
transmitting a request to said user to modify at least one parameter within said source entity, each parameter being related to the source user account and being outwardly visible via said network; and
connecting to said source entity to verify modification of said at least one parameter.

10. The method according to claim 9, wherein said authenticating step further comprises the steps of:
receiving a communication detailing said modification from said user.

11. The method according to claim 9, wherein said at least one parameter is a password hint in the event that said user forgets a password used to access said source user account.

12. A system to facilitate importation of user profile data over a network, said system comprising:
means for receiving a request to import said user profile data from a user, said user profile data being stored in a source user account within a source entity; and
prior to said importation of said user profile data, means for authenticating said source user account as being associated with said user.

13. The system according to claim 12, further comprising:
means for receiving said user profile data from said source entity; and
means for merging said user profile data within a destination user account associated with said user.

14. The system according to claim 12, further comprising:
means for receiving said user profile data from said source entity; and
means for using said user profile data to create a destination user account associated with said user.

15. The system according to claim 12, further comprising:
means for transmitting a request to said user to provide authentication data for said source user account;
means for receiving said authentication data; and
means for accessing said source user account within said source entity using said authentication data.

16. The system according to claim 15, wherein said authentication data is a valid password used to access said source user account.

17. The system according to claim 12, further comprising:
means for installing a destination client on a client machine associated with said user;
means for prompting said user to access said source user account within said source entity; and
means for monitoring said access of said source user account using said destination client to authenticate said source user account as being associated with said user.

18. The system according to claim 12, further comprising:
means for installing a destination client on a client machine associated with said user;
means for prompting said user to access said source entity using a link accessible only with valid authentication data; and
means for monitoring said access of said source entity using said destination client to authenticate said source user account as being associated with said user.

19. The system according to claim 18, further comprising:
means for determining if said user receives information from said link via a Hyper Text Transfer Protocol (HTTP) request.

20. The system according to claim 12, further comprising:
means for transmitting a request to said user to modify at least one parameter within said source entity, each parameter being related to the source user account and being outwardly visible via said network; and
means for connecting to said source entity to verify modification of said at least one parameter.

21. The system according to claim 20, further comprising:
means for receiving a communication detailing said modification from said user.

22. The system according to claim 20, wherein said at least one parameter is a password hint in the event that said user forgets a password used to access said source user account.

23. A computer readable medium containing executable instructions, which, when executed in a processing system, cause said processing system to perform a method to facilitate importation of user profile data over a network, said method comprising the steps of:
receiving a request to import said user profile data from a user, said user profile data being stored in a source user account within a source entity; and
prior to said importation of said user profile data, authenticating said source user account as being associated with said user.

24. The computer readable medium according to claim 23, wherein said method further comprises the steps of:
receiving said user profile data from said source entity; and
merging said user profile data within a destination user account associated with said user.

25. The computer readable medium according to claim 23, wherein said method further comprises the steps of:
receiving said user profile data from said source entity; and
using said user profile data to create a destination user account associated with said user.

26. The computer readable medium according to claim 23, wherein said authenticating step further comprises the steps of:
transmitting a request to said user to provide authentication data for said source user account;
receiving said authentication data; and
accessing said source user account within said source entity using said authentication data.

27. The computer readable medium according to claim 26, wherein said authentication data is a valid password used to access said source user account.

28. The computer readable medium according to claim 23, wherein said authenticating step further comprises the steps of:
installing a destination client on a client machine associated with said user;
prompting said user to access said source user account within said source entity; and
monitoring said access of said source user account using said destination client to authenticate said source user account as being associated with said user.

29. The computer readable medium according to claim 23, wherein said authenticating step further comprises the steps of:
installing a destination client on a client machine associated with said user;
prompting said user to access said source entity using a link accessible only with valid authentication data; and
monitoring said access of said source entity using said destination client to authenticate said source user account as being associated with said user.

30. The computer readable medium according to claim 29, wherein said monitoring step further comprises the steps of:
determining if said user receives information from said link via a Hyper Text Transfer Protocol (HTTP) request.

31. The computer readable medium according to claim 23, wherein said authenticating step further comprises the steps of:
transmitting a request to said user to modify at least one parameter within said source entity, each parameter being related to the source user account and being outwardly visible via said network; and
connecting to said source entity to verify modification of said at least one parameter.

32. The computer readable medium according to claim 31, wherein said authenticating step further comprises the steps of:
receiving a communication detailing said modification from said user.

33. The computer readable medium according to claim 31, wherein said at least one parameter is a password hint in the event that said user forgets a password used to access said source user account.

34. A system to facilitate importation of user profile data over a network, said system comprising:
a client machine associated with a user; and
a destination entity coupled to said client machine over said network, said destination entity further comprising authentication servers for receiving a request to import said user profile data from said user, said user profile data being stored in a source user account within a source entity coupled to said destination entity over said network, said authentication servers for authenticating said source user account as being associated with said user prior to said importation of said user profile data.

35. The system according to claim 34, wherein said authentication servers further receive said user profile data from said source entity and merge said user profile data within a destination user account associated with said user.

36. The system according to claim 34, wherein said authentication servers further receive said user profile data from said source entity and use said user profile data to create a destination user account associated with said user.

37. The system according to claim 34, wherein said authentication servers further transmit a request to said user to provide authentication data for said source user account, receive said authentication data, and access said source user account within said source entity using said authentication data.

38. The system according to claim 37, wherein said authentication data is a valid password used to access said source user account.

39. The system according to claim 34, wherein said authentication servers further install a destination client on said client machine associated with said user, prompt said user to access said source user account within said source entity, and monitor said access of said source user account using said destination client to authenticate said source user account as being associated with said user.

40. The system according to claim 34, wherein said authentication servers further install a destination client on said client machine associated with said user, prompt said user to access said source entity using a link accessible only with valid authentication data, and monitor said access of said source entity using said destination client to authenticate said source user account as being associated with said user.

41. The system according to claim 40, wherein said authentication servers further determine if said user receives information from said link via a Hyper Text Transfer Protocol (HTTP) request.

42. The system according to claim 34, wherein said authentication servers further transmit a request to said user to modify at least one parameter within said source entity, each parameter being related to the source user account and being outwardly visible via said network, and connect to said source entity to verify modification of said at least one parameter.

43. The system according to claim 42, wherein said authentication servers further receive a communication detailing said modification from said user.

44. The system according to claim 42, wherein said at least one parameter is a password hint in the event that said user forgets a password used to access said source user account.
